(19) United States
(12) Patent Application Publication
(10) Pub. No.: US 2026/0286853 A1
(43) Pub. Date: Sep. 24, 2026

(54) METHOD FOR THE HEAT TREATMENT OF A BI-MATERIAL METAL PART AND DEVICE FOR CARRYING OUT THE METHOD

(71) Applicant: SAFRAN, Paris (FR)

(72) Inventors: Vincent MAGUIN, Moissy-Cramayel (FR); Aboubakry AGNE, Moissy-Cramayel (FR); Serge Vladimir TENNE, Moissy-Cramayel (FR)

(73) Assignee: SAFRAN, Paris (FR)

(21) Appl. No.: 19/490,127

(22) PCT Filed: Jun. 3, 2024
(86) PCT No.: PCT/FR2024/050706

§ 371 Date: Dec. 4, 2025

(30) Foreign Application Priority Data
Jun. 6, 2023 (FR) 2305645

(51) Int. Cl. F01D 5/28; C22F 1/00; C22F 1/02; C22F 1/10; F27B 9/02; F27D 99/00

(52) U.S. Cl. CPC F01D 5/286; C22F 1/002; C22F 1/02; C22F 1/10; F27B 9/028; F05D 2230/40; F27D 99/007

(57) ABSTRACT

metal blade including a first part and a second part each made of different materials, and the method including: a first heat treatment at a first temperature, the first heat treatment being undergone by only the first part of the metal blade, and a second heat treatment at a second temperature lower than the first temperature, the second heat treatment being undergone by the second part of the metal blade.

### TECHNICAL FIELD

This disclosure relates to a heat treatment method for a multi-material metal turbine blade, as well as the devices that enable the implementation of this method.

Such a method can, for example, be used to form metal turbine blades for a turbomachine. Such blades are particularly adapted for applications in high-pressure turbines and compressors.

### PRIOR ART

In order to build more efficient turbomachines, operating temperatures within the turbomachine are becoming increasingly high. This is particularly true for the hot stages of the turbomachine (high-pressure compressor, combustion chamber, and high-pressure turbine). To meet these increasingly demanding conditions, new multi-material metal blades have been designed. This allows the blade materials to be adapted to the more demanding conditions within the turbomachine during operation, taking into account local thermomechanical stresses.

However, each material of multi-material blades has different properties. This is particularly problematic for blade finishing steps, such as heat treatment steps that dissolve certain crystalline precipitates and the eutectics formed during solidification. In particular, the temperature ranges for heat treatment of the different materials composing a multi-material blade may be disparate.

In such circumstances, the material with the lowest temperature resistance limits the heat treatment of other materials. Consequently, the microstructure of materials specifically chosen for their properties over a certain temperature range is degraded. Thus, the desired properties may, in some cases, not be achieved. The blade's performance is therefore reduced.

Therefore, there is a real need for improvement in this area. In particular, there is a need for methods for finishing multi-material parts that are free, at least in part, from the aforementioned disadvantages. In this disclosure, the term “finishing method” refers to the end-of-line manufacturing operations applied to a part. For example, heat treatment can be considered a finishing method.

### DISCLOSURE OF THE INVENTION

This disclosure relates to a heat treatment method for a multi-material metal turbine blade, the metal blade comprising a first part and a second part each made of different materials, the method comprising: a first heat treatment at a first temperature, the first heat treatment being undergone by only the first part of the metal blade, and a second heat treatment at a second temperature lower than the first temperature, the second heat treatment being undergone by the second part of the metal blade.

According to this method, it is possible to heat-treat two distinct parts of the same blade, each with different properties, using a heat treatment adapted to each area.

This is particularly adapted to multi-material metal blades of a turbomachine. Indeed, this solution overcomes the difficulties previously encountered in finishing bi-material blades, where the temperature ranges of the heat treatments required for the blade materials are disparate.

In some embodiments, the first and second heat treatments are successive.

This configuration improves the thermal accuracy of the heat treatment. In particular, this configuration is advantageous for limiting the effects of thermal diffusion within the metal blade.

In some embodiments, the first and second heat treatments are simultaneous.

This configuration saves time because the blade materials undergo their respective heat treatments simultaneously. The overall heat treatment time for the blade is therefore shorter.

In some embodiments, the method comprises a single quenching step planned after the first and second heat treatments.

This configuration saves time, energy, and money, as it eliminates the need for an additional heating step following the initial heat treatment. Furthermore, performing a single quenching method prevents recrystallization, which can occur when the thermomechanical stresses on the part decrease.

In some embodiments, during the first heat treatment, the second part of the metal blade is cooled by a fluid.

The fluid can be a gas or a liquid.

In this configuration, a thermal gradient is established between the first part and the second part. This thermal gradient limits the temperature of the second part. In this way, the impact of the heat treatment of the first part on the second part is greatly reduced, or even eliminated.

The present disclosure also relates to a furnace adapted for the heat treatment of a multi-material metal blade of a turbomachine comprising: a hot enclosure configured to be maintained at a first temperature greater than 1250° C. and, to receive a first part of the metal blade, a cold enclosure configured to be maintained at a second temperature greater than 1100° C. and lower than the first temperature, and to receive a second part of the metal blade, and in which the furnace comprises a thermally insulating separation screen separating the hot enclosure from the cold enclosure, and configured to be traversed by the metal blade.

Such a furnace makes it easy to implement the method of the present invention. In particular, such a furnace is particularly adapted for performing simultaneous heat treatments on metal blades comprising several materials.

In some embodiments, the cold enclosure comprises a fluid cooling system configured to cool the second part of the blade.

In some embodiments, the cold enclosure comprises a cooling system and a cavity configured to accommodate and cool the second part of the blade.

In this configuration, the impact of temperature within the metal blade is reduced.

The aforementioned features and advantages, as well as others, will become apparent upon reading the detailed description that follows, along with examples of implementations of the proposed device and method. This detailed description refers to the attached drawings.

### BRIEF DESCRIPTION OF THE DRAWINGS

The attached drawings are schematic and are primarily intended to illustrate the principles of the presentation.

In these drawings, from one figure to another, identical elements (or parts of elements) are identified by the same reference symbols.

FIG. 1 schematically shows a furnace for carrying out the method according to a first embodiment.

FIG. 2 schematically shows a furnace according to a first variant.

FIG. 3 schematically shows a furnace according to a second variant.

FIG. 4 schematically shows a furnace according to a third variant.

FIG. 5 shows the evolution of the temperature undergone by the first part and the second part of the metal blade as a function of time, according to a first embodiment of the method of the invention.

FIG. 6 shows the evolution of the temperature undergone by the first part and the second part of the metal blade as a function of time, according to a second embodiment of the method of the invention.

FIG. 7 shows the evolution of the temperature undergone by the first part and the second part of the metal blade as a function of time, according to a third embodiment of the method of the invention.

FIG. 8 shows the evolution of the temperature undergone by the first part and the second part of the metal blade as a function of time, according to a fourth embodiment of the method of the invention.

### DESCRIPTION OF THE EMBODIMENTS

To make the disclosure more concrete, an example of the device is described in detail below, with reference to the attached drawings. It should be noted that the invention is not limited to this example.

This disclosure focuses on the finishing of a metal blade. The first part 20 and the second part 22 are made of two different materials. For example, the first part 20 could be the commercial alloy CMSX-4® while the second part could be the commercial alloy AM1®s.

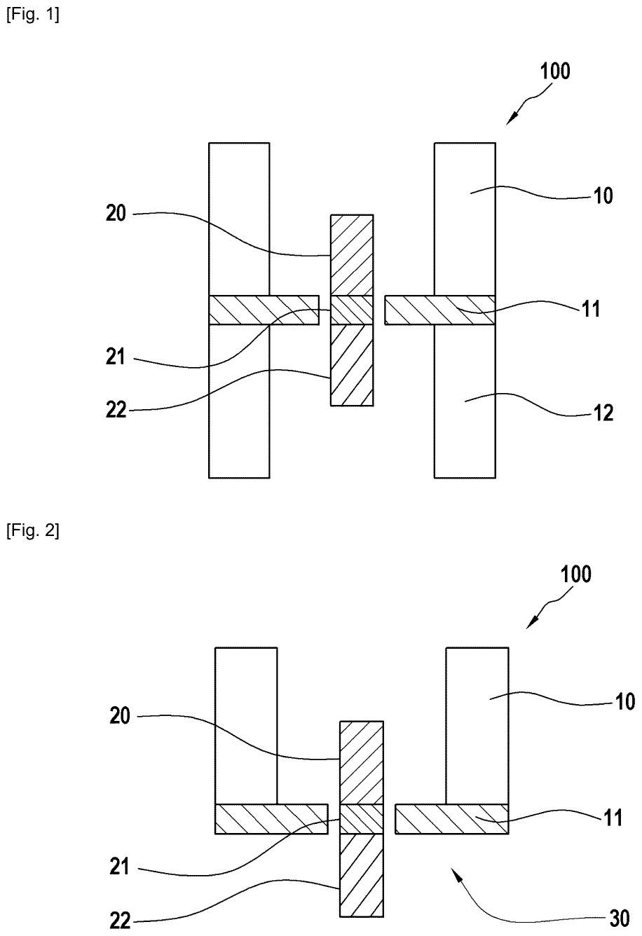

FIG. 1 shows a furnace 100 suitable for carrying out the method of the invention. The furnace 100 comprises a hot enclosure 10 and a cold enclosure 12. A separation screen 11 separates the hot enclosure 10 and the cold enclosure 12. The hot enclosure 10 and the cold enclosure 12 can, for example, be suitable for heating a material by convection or by induction.

The separation screen 11 is thermally insulating. For example, the separation screen 11 can maintain a temperature difference between the hot enclosure 10 and the cold enclosure 12 greater than 20° C., for a separation screen 11 having a thickness greater than 1 mm.

A metal blade comprising a first part 20, a second part 22 and a connecting part 21 linking the first part 20 and the second part 22 is arranged in the furnace 100. For example, the first part 20 may correspond to the vane of the blade, the connecting part 21 may correspond to the platform of the blade and the second part 22 may correspond to the root of the blade.

In this embodiment, the blade is arranged in the furnace 100 such that the first part 20 of the blade is in the hot enclosure 10 and the second part of the blade 22 is in the cold enclosure 12. The connecting part 21 is then in the same plane as the separation screen 11 of the furnace 100. It should be noted that the reverse configuration is also feasible, so that the first part 20 is arranged in the cold enclosure 12 and the second part 22 is arranged in the hot enclosure 10.

FIG. 2 shows a first variant of the furnace 100, comprising a cooling system 30. In this first variant, the cooling system 30 comprises a pressure-controlled or vacuum enclosure. This enclosure can replace the cold enclosure 12, or simply be comprised within the cold enclosure 12. To achieve cooling, the cooling enclosure 30 can be cooled using a gas, typically an inert gas such as argon.

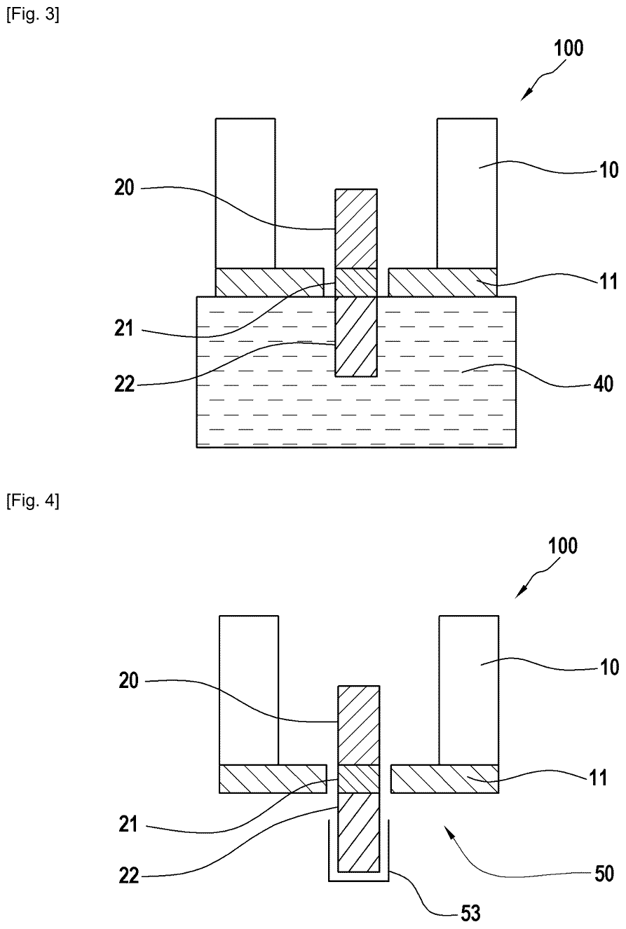

FIG. 3 shows a second variant of the furnace 100, comprising a cooling system 40. In this second variant, the cooling system 40 comprises an enclosure configured to receive a liquid into which the second part of the blade 22 can be immersed. This enclosure can be comprised within the cold enclosure 12. To achieve cooling, the cooling enclosure 40 may comprise a liquid, typically a liquid metal such as liquid aluminum.

FIG. 4 shows a third variant of the furnace 100, comprising a cooling system 50. In this third variant, the cooling system 50 comprises a cavity 53 (tooling) configured to hold the second part 22. The cavity 53 is cooled and may, for example, comprise a water or cryogenic gas cooling circuit. The cavity 53 may replace the cold enclosure 12 or simply be comprised within the cold enclosure 12.

In order to implement the method of the present invention, the metal blade is placed in the furnace 100. Attention is now directed to the control of the furnace 100 which results in the heat treatment of the metal blade.

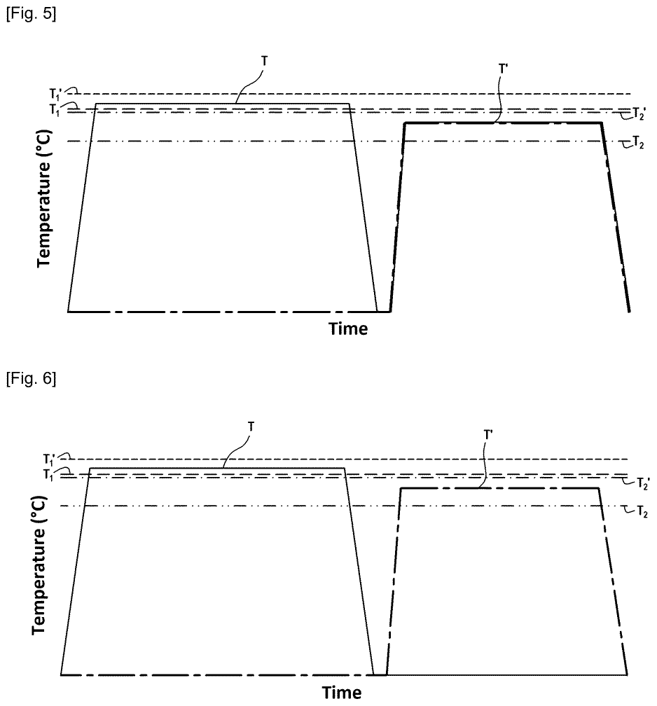

FIG. 5 shows the evolution of the temperature undergone by the first part 20 and the second part 22 as a function of time, for a heat treatment according to a first embodiment of the method of the invention.

Each material has a solvus temperature and a burn temperature. To achieve satisfactory heat treatment for a material, it must be heated above its solvus temperature but below its burn temperature. Indeed, above the burn temperature, the material degrades.

The solvus and burn temperatures are respectively noted as T1 and T1′ for the first material and T2 and T2′ for the second material.

In the first embodiment, and as shown in FIG. 1, the first part 20 of the blade is heated to a temperature T comprised between T1 and T1′, while the second part 22 is maintained at a temperature lower than T2, preferably much lower than T2. For example, the second part 22 can be maintained at 300° C., or even at ambient temperature.

The first part 20 is maintained for a certain time at this temperature T, so that the first part 20 is heat-treated. For example, the first part 20 can be maintained for at least 10 hours at a temperature greater than 1250° C., preferably greater than 1310° C. In the present example, the first part 20 is maintained at a constant temperature T. However, the heat-treatment temperature T can be variable, and for example, consist of a succession of temperature plateaus. Once the heat treatment of the first part 20 is complete, the first part 20 is cooled. For example, the first part 20 can be cooled by quenching. Quenching can, for example, be carried out using a known method, with turbinated argon. Optionally, the first part can be cooled to a temperature that can be ambient temperature.

Next, the first part 20 and the second part 22 are heated to a temperature T′ comprised between T2 and T2′. The first part 20 and the second part 22 are then maintained at this temperature T′ for a certain time, so that the second part 22 undergoes heat treatment. For example, the second part 22 can be maintained for at least 1 hour at a temperature T′ greater than 1100° C., preferably greater than 1290° C. In this example, the second part 22 is maintained at a constant temperature T′. However, the heat treatment temperature T′ can be variable, and for example, consist of a succession of different temperature plateaus.

Once the heat treatment of the second part 22 is complete, the first part 20, the connecting part 21, and the second part 22 are cooled. For example, the first part 20, the connecting part 21, and the second part 22 can be cooled by quenching.

FIG. 6 shows the evolution of the temperature undergone by the first part 20 and the second part 22 of the metal blade as a function of time, according to a second embodiment of the method of the invention. The second embodiment is identical to the first embodiment except for the following: during the heat treatment of the second part 22, the first part is maintained at a temperature lower than T2, preferably much lower than T2. For example, the first part can be maintained at 300° C., or even at ambient temperature.

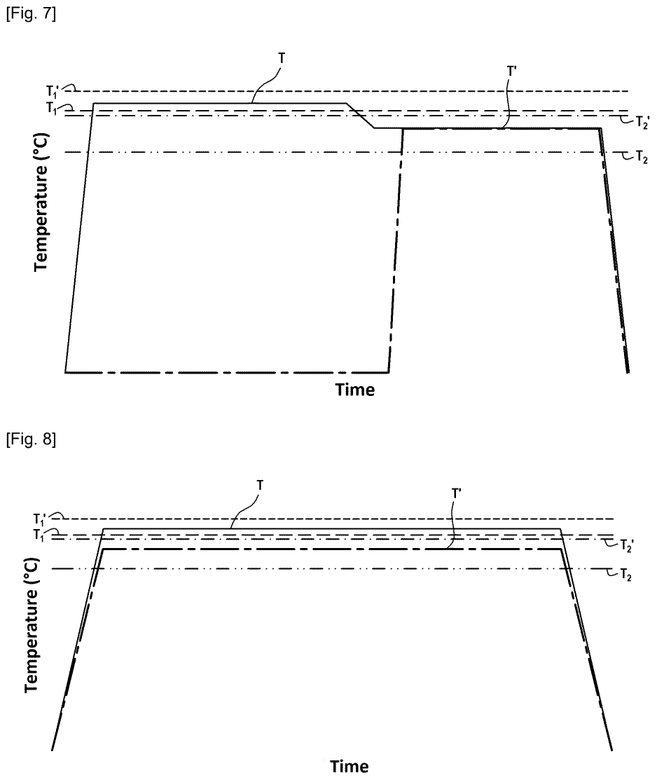

FIG. 7 shows the evolution of the temperature undergone by the first part 20 and the second part 22 of the metal blade as a function of time, according to a third embodiment of the method of the invention. The third embodiment is identical to the first embodiment except for the following: at the end of the heat treatment of the first part 20, the first part is cooled to a temperature T′ comprised between T2 and T2′. This temperature T′ is the heat treatment temperature of the second part 22. The second part 22 is then heat-treated and brought to a temperature T′. During the heat treatment of the second part 22, the first part 20 is also maintained at temperature T′.

FIG. 8 shows the evolution of the temperature undergone by the first part 20 and the second part 22 of the metal blade as a function of time, according to a fourth embodiment of the method of the invention. In the fourth embodiment of the invention, the heat treatment of the first part 20 and the heat treatment of the second part 22 are carried out simultaneously.

Thus, in the fourth embodiment, the first part 20 of the blade is brought to a temperature T comprised between T1 and T1′, and the second part 22 is simultaneously brought to a temperature T′ comprised between T2 and T2′.

The first part 20 and the second part 22 are maintained at temperatures T and T′ respectively until they are heat-treated. For example, the first part 20 and the second part 22 can be maintained at temperatures T and T′ respectively for at least 10 hours.

The first part 20 and the second part 22 are then cooled, for example by quenching.

Optionally, the first part 20 and the second part 22 can be brought to the respective temperatures T and T′ separately and/or cooled separately, so that the holding times at temperatures T and T′ are different.

Although the present invention was described with reference to specific embodiments, it is evident that modifications and changes can be made to these examples without departing from the general scope of the invention as defined by the claims. In particular, individual features of the various embodiments illustrated/mentioned can be combined in additional embodiments. Therefore, the description and drawings should be considered in an illustrative rather than restrictive sense.

It is also evident that all the characteristics described with reference to a method are transposable, alone or in combination, to a device, and conversely, all the characteristics described with reference to a device are transposable, alone or in combination, to a method.

1. A heat treatment method for a multi-material metal turbine blade,
the metal blade comprising a first part and a second part, each made of different materials,
the method comprising:
the positioning of the metal blade in a furnace including a hot enclosure, a cold enclosure and a separation screen, said separation screen separating the hot enclosure from the cold enclosure, the first part of the metal blade being arranged in one of the hot enclosure and the cold enclosure, the second part being arranged in the other of the hot enclosure and the cold enclosure,
a first heat treatment at a first temperature, the first heat treatment being undergone by only the first part of the metal blade, and
a second heat treatment at a second temperature lower than the first temperature, the second heat treatment being undergone by the second part of the metal blade.

2. The method according to claim 1, wherein the first and second heat treatments are successive.

3. The method according to claim 1, wherein the first and second heat treatments are simultaneous.

4. The method according to claim 1, comprising a single quenching step planned after the first and second heat treatments.

5. The method according to claim 1, wherein during the first heat treatment, the second part of the metal blade is cooled by a fluid.

6. A furnace adapted for the heat treatment of a multi-material metal blade of a turbomachine comprising:
a hot enclosure configured to be maintained at a first temperature greater than 1250° C., and to receive a first part of the metal blade,
a cold enclosure configured to be maintained at a second temperature greater than 1100° C. and lower than the first temperature, and to receive a second part of the metal blade, and
in which the furnace comprises a thermally insulating separation screen separating the hot enclosure from the cold enclosure, and configured to be traversed by the metal blade so as to keep the first part of the metal blade in the hot enclosure during a first heat treatment and to keep the second part of the metal blade in the cold enclosure during a second heat treatment.

7. The furnace according to claim 6, wherein the cold enclosure comprises a fluid cooling system configured to cool the second part of the blade.

8. The furnace according to claim 6, wherein the cold enclosure comprises a cooling system and a cavity configured to accommodate and cool the second part of the blade.
